(19) United States
(12) Patent Application Publication
(10) Pub. No.: US 2020/0189612 A1
(43) Pub. Date: Jun. 18, 2020

(54) AUTOMATIC DRIVER ASSISTANCE SYSTEM

(71) Applicant: Continental Automotive Systems Inc., Auburn Hills, MI (US)

(72) Inventors: Yoshiro Shimizu, Tlaquepaque (MX); Alan Sanchez, Tlaquepaque (MX); Mauricio Gonzalez, Guadalajara (MX); Julio Angulo, Zapopan (MX)

(21) Appl. No.: 16/221,988

(22) Filed: Dec. 17, 2018

(51) Int. Cl. B60W 50/12; B60W 40/09; G05D 1/00

(52) U.S. Cl. CPC B60W 50/12; G05D 1/0061; B60W 40/09

(57) ABSTRACT

A disclosed method of automatically assisting a driver of a vehicle according to an exemplary embodiment of this disclosure includes determining whether a mobile device is in a vehicle, determining whether an application on the mobile device is being used by a driver of the vehicle, and automatically activating a driver assist mode when the driver is using the application. A system for automatically assisting a driver of a vehicle is also disclosed.

### TECHNICAL FIELD

The present disclosure relates to a method and system for automatically activating driver assistance functions when a driver of a vehicle is distracted with a mobile device.

### BACKGROUND

Advancements in available sensor technology have led to the ability to improve safety systems for vehicles. Arrangements and methods for detecting and avoiding collisions using the improved sensor technology are being implemented in passenger vehicles, commercial vehicles, and other light vehicles. These systems are referred to as driver assistance systems. Driver assistance systems use sensors located on the vehicle to detect oncoming collisions or similar hazardous events. The driver assistance systems can warn the driver and/or take over control of the vehicle, by providing evasive maneuvers such as autonomous or assisted braking and/or steering. Driver assistance systems may be useful when a driver is distracted, for example. These driver assistance systems have helped in the development of autonomous driving systems.

### SUMMARY

A disclosed method of automatically assisting a driver of a vehicle according to an exemplary embodiment of this disclosure includes determining whether a mobile device is in a vehicle, determining whether an application on the mobile device is being used by a driver of the vehicle, and automatically activating a driver assist mode when the driver is using the application.

In a further embodiment of the foregoing method, the driver assist mode includes one of a brake assist or steering assist function.

In a further embodiment of the foregoing method, the method includes deactivating the driver assist mode manually when the driver is finished using the application.

In a further embodiment of the foregoing method, the deactivating the driver assist mode comprises pressing a button or switch.

In a further embodiment of the foregoing method, the deactivating the driver assist mode comprises the driver giving a voice command.

In a further embodiment of the foregoing method, the deactivating the driver assist mode comprises maneuvering a steering wheel of the vehicle.

In a further embodiment of the foregoing method, the application is one of a phone or messenger application.

In a further embodiment of the foregoing method, a controller on the vehicle performs the determining steps and the activating of the driver assist mode.

In a further embodiment of the foregoing method, the mobile device has a driver assist application that performs the determining steps and communicates with a controller on the vehicle for the activating of the driver assist mode.

In a further embodiment of the foregoing method, the mobile device is configured to communicate with the vehicle wirelessly.

A system for automatically assisting a driver of a vehicle includes a controller on the vehicle. The controller is configured to determine whether a mobile device is in the vehicle, determine whether an application on the mobile device is being used by a driver of the vehicle, and automatically activate a driver assist mode when the driver is using the application.

In a further embodiment of the foregoing system, the controller is in communication with a driver assistance system to activate the driver assist mode.

In a further embodiment of the foregoing system, the driver assistance system is configured to gather data from a sensor on the vehicle.

In a further embodiment of the foregoing system, the driver assist mode includes one of a brake assist or steering assist function.

In a further embodiment of the foregoing system, the controller is configured to switch between a normal driving mode and the driver assist mode, wherein the driver assist mode has more driver assistance functions than the normal driving mode.

In a further embodiment of the foregoing system, the controller is configured to communicate with the mobile device wirelessly.

In a further embodiment of the foregoing system, the application is one of a phone or messenger application.

In a further embodiment of the foregoing system, the controller is configured to deactivate the driver assist mode when the driver is finished using the application.

In a further embodiment of the foregoing system, the controller is configured to deactivate the driver assist mode upon receipt of a manual input from the driver.

In a further embodiment of the foregoing system, the manual input is one of a button, voice command, or steering wheel maneuver.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a schematic view of a vehicle with an exemplary automatic driver assistance system.

FIG. 2A is a schematic view of an example driver assistance system.

FIG. 2B is a schematic view of an example driver assistance system.

FIG. 3 is a flowchart diagram summarizing an example method of automatically activating a driver assist mode.

### DETAILED DESCRIPTION

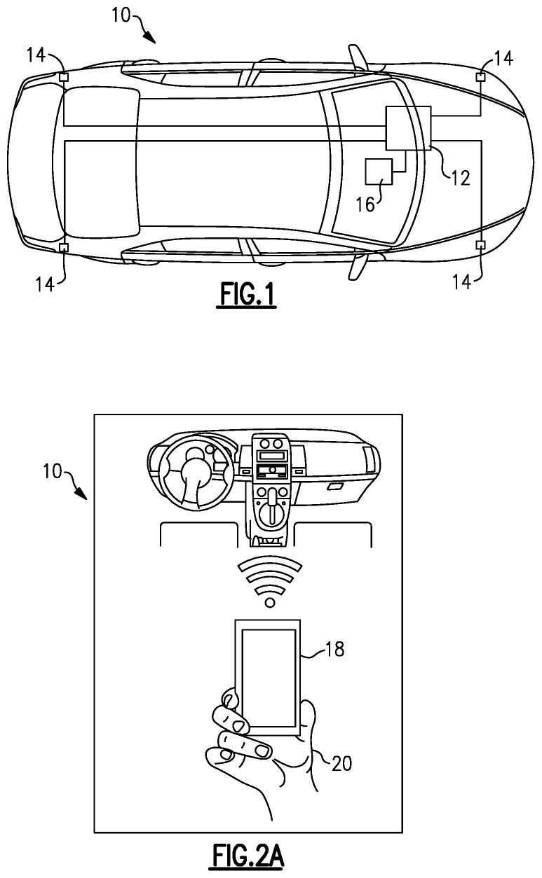

FIG. 1 schematically illustrates a vehicle 10 including a driver assistance system 12. The driver assistance system 12 may perform driver assistance functions that help avoid collisions by alerting the driver to potential problems and/or taking over control of the vehicle 10. The driver assistance system 12 gathers information about the environment from sensors 14. Although four sensors 14 are illustrated, more or fewer sensors 14 may be placed throughout the vehicle 10 to provide information to the driver assistance system 12. Data from the sensors 14 permit the driver assistance system 12 to respond appropriately to the driving conditions and environment. Example driver assist functions of the driver assistance system 12 may include a brake assist and/or steering assist, for example. The driver assistance system 12 may include blind-spot monitoring, adaptive cruise control, automated lighting, collision avoidance, electronic stability control, anti-lock brakes, lane departure warning, adaptive cruise control, lane departure, lane centering, traction control or other functions for assisting the driver. The driver assistance system 12 may provide one, all, or any combination of the above listed driver assistance functions. In a further embodiment, the driver assistance system 12 may operate the vehicle 10 fully autonomously.

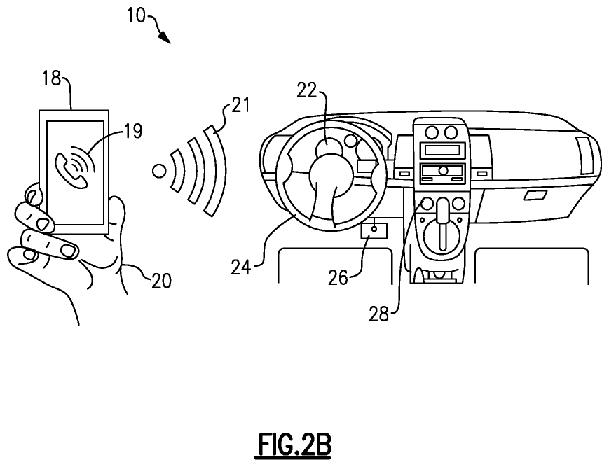

A driver 20 (shown in FIGS. 2A-2B) of the vehicle 10 may not want all of the possible driver assistance functions operating at all times. For example, the driver 20 may have preferences to optimize fuel economy or vehicle speed. Further, particular situations may not be ideal for some driver assistance functions, such as in construction zones when lane changes may be difficult to detect or in driving conditions requiring a driver to drive near the edge of a lane, e.g. while pulling a trailer. Thus, the vehicle 10 has a “normal driving mode,” which is the default operational mode of the vehicle 10, and “a driver assist mode” or “autonomous mode.” The normal driving mode may not have any driver assistance functions enabled, or may have some driver assistance functions activated. The “driver assist mode” or “autonomous mode,” has additional driver assistance functions enabled. For example, the normal driving mode may use lane departure warnings, while the driver assist mode uses automatic lane centering and brake assist. That is, the driver assist mode includes more driver assistance functions than the normal driving mode.

A controller 16 communicates with the driver assistance system 12 to switch between the normal driving mode and the driver assist mode. The controller 16 may control various features of the driver assistance system 12, for example. While exemplified herein as a single controller 16, it is understood that the functions of a driver assistance system 12 can be performed by multiple distinct controllers that are capable of communicating with each other either directly or through an indirect communication interface. Although controller 16 is illustrated as separate from the driver assistance system 12, the controller 16 may be integrated with the driver assistance system 12 in some embodiments.

The controller 16 is configured to switch from the normal driving mode to the driver assist mode when a driver 20 of the vehicle 10 is distracted. A driver 20 may face many distractions while driving. One such distraction is a mobile device 18, such as a cellular phone. While the driver 20 is using a mobile device 18, the driver 20 may not be paying close attention to driving. In such distracted instances, functions of the driver assistance system 12 may be particularly helpful.

The disclosed controller 16 automatically activates the driver assist mode via the driver assistance system 12 when the driver 20 is using a mobile device 18, as shown in FIGS. 2A-2B. In an embodiment, the controller 16 communicates with the mobile device 18. The mobile device 18 may send a wireless signal 21 to the controller 16, for example. The controller 16 may detect whether a mobile device 18 is present in the vehicle 10, and detects whether the mobile device 18 is being used. In some embodiments, the controller 16 may detect whether a particular application 19 is in use on the mobile device 18, such as a phone or messaging application. In one example, an application is installed onto the mobile device 18 to facilitate the communication with the controller 16. The controller 16 or mobile device 18 may be programmed such that only the driver's mobile device 18 communicates with the controller 16, in case there are multiple passengers with additional mobile devices.

After the driver 20 is finished using the mobile device 18, the driver 20 manually turns off the driver assist mode. In some embodiments, a display 22 indicates that the vehicle 10 is operating in driver assist mode. The driver 20 may manually turn off the driver assist mode by pressing a button or switch 28, using a voice command, tapping the brake pedal 26, or taking control of the steering wheel 24, for example.

Although the application 19 is illustrated as being an application on the mobile device 18, the controller 16 may automatically turn on the driver assistance system 12 for other distractions. For example, the controller 16 may activate driver assist mode when the controller 16 detects the driver 20 interacting with features embedded in the vehicle 10. For example, the controller 16 may automatically activate the driver assist mode when the driver 20 is interacting with systems in the vehicle 10, such as a radio or navigation system.

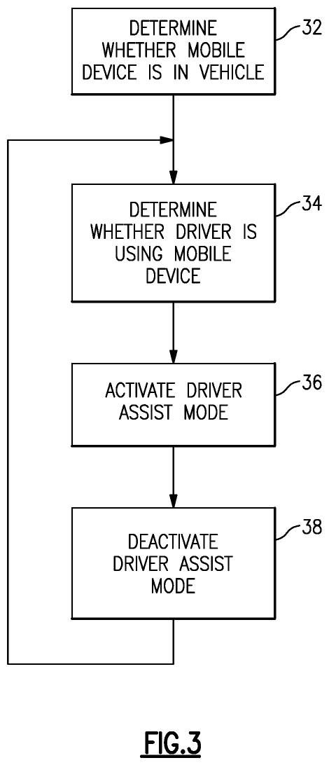

FIG. 3 summarizes an example method to automatically switch from normal driving mode to driver assist mode. First, the controller 16 or mobile device 18 determine whether the mobile device 18 is present in the vehicle 10 at 32. The controller 16 or mobile device 18 determine whether the driver 20 is using an application 19 on the mobile device 18 at 34. When the controller 16 detects that the driver 20 is using an application 19 on the mobile device 18, the controller activates the driver assist mode at 36. That is, when the controller 16 detects the driver 20 is likely distracted with the mobile device 18, driver assist functions are automatically enabled.

When the driver 20 is finished using the application 19 on the mobile device 18, the driver 20 must manually deactivate the driver assist mode at 38. The driver 20 may turn off the driver assist mode by pressing a button or switch 28, using a voice command, tapping the brake pedal 26, or taking control of the steering wheel 24, for example. This manual deactivation of the driver assist mode ensures that the driver 20 is fully attentive again after having been distracted. Once the driver 20 is finished using the mobile device 18 and has turned off the driver assist mode at 38, the vehicle 10 returns to normal driving mode.

The disclosed system and method improves driver safety by automatically enabling driver assistance functions when the driver is distracted. This may also give the driver peace of mind while driving that such driver assistance functions will take over in the event the driver becomes distracted with a mobile device.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A method of automatically assisting a driver of a vehicle, the method comprising:
determining whether a mobile device is in a vehicle;
determining whether an application on the mobile device is being used by a driver of the vehicle;
automatically activating a driver assist mode when the driver is using the application.

2. The method of claim 1, wherein the driver assist mode includes one of a brake assist or steering assist function.

3. The method of claim 1, comprising:
deactivating the driver assist mode manually when the driver is finished using the application.

4. The method of claim 3, wherein the deactivating the driver assist mode comprises pressing a button or switch.

5. The method of claim 3, wherein the deactivating the driver assist mode comprises the driver giving a voice command.

6. The method of claim 3, wherein the deactivating the driver assist mode comprises maneuvering a steering wheel of the vehicle.

7. The method of claim 1, wherein the application is one of a phone or messenger application.

8. The method of claim 1, wherein a controller on the vehicle performs the determining steps and the activating of the driver assist mode.

9. The method of claim 1, wherein the mobile device has a driver assist application that performs the determining steps and communicates with a controller on the vehicle for the activating of the driver assist mode.

10. The method of claim 1, wherein the mobile device is configured to communicate with the vehicle wirelessly.

11. A system for automatically assisting a driver of a vehicle, the system comprising:
a controller on a vehicle, the controller configured to:
determine whether a mobile device is in the vehicle;
determine whether an application on the mobile device is being used by a driver of the vehicle;
automatically activate a driver assist mode when the driver is using the application.

12. The system of claim 11, wherein the controller is in communication with a driver assistance system to activate the driver assist mode.

13. The system of claim 12, wherein the driver assistance system is configured to gather data from a sensor on the vehicle.

14. The system of claim 11, wherein the driver assist mode includes one of a brake assist or steering assist function.

15. The system of claim 11, wherein the controller is configured to switch between a normal driving mode and the driver assist mode, wherein the driver assist mode has more driver assistance functions than the normal driving mode.

16. The system of claim 11, wherein the controller is configured to communicate with the mobile device wirelessly.

17. The system of claim 11, wherein the application is one of a phone or messenger application.

18. The system of claim 11, wherein the controller is configured to deactivate the driver assist mode when the driver is finished using the application.

19. The system of claim 18, wherein the controller is configured to deactivate the driver assist mode upon receipt of a manual input from the driver.

20. The system of claim 19, wherein the manual input is one of a button, voice command, or steering wheel maneuver.
